(19) United States
(12) Patent Application Publication
(10) Pub. No.: US 2007/0189766 A1
(43) Pub. Date: Aug. 16, 2007

(54) LENS BARREL AND IMAGE PICKUP APPARATUS

(75) Inventors: Takumi KUWAHARA, Nara (JP); Takashi KOIKE, Hyogo (JP); Hiroyasu FUJINAKA, Osaka (JP); Atsushi HASEGAWA, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/673,286

(22) Filed: Feb. 9, 2007

(30) Foreign Application Priority Data
Feb. 10, 2006 (JP) JP2006-033372

(51) Int. Cl. G03B 17/00

(52) U.S. Cl. 396/542

(57) ABSTRACT

A lens barrel and an image pickup apparatus equipped with the lens barrel of the present invention include a movement frame unit movable in an optical axis direction of a lens with respect to a base unit, and a flexible printed circuit including a stationary portion fixed to the movement frame unit and an extension extending from the stationary portion, the base unit includes a protrusion protruding in a direction in which the movement frame unit is placed, the extension is placed so as to extend from the stationary portion to reach at least the base unit or another member via the protrusion, and a part between the stationary portion and the protrusion is placed to be curved substantially in a U-shape. Due to this configuration, a lens barrel capable of reducing time and labor during assembly can be realized at low cost.

### BACKGROUND OF THE INVENTION

1. Field of the Invention

The present invention relates to a lens barrel containing an optical lens. The present invention also relates to an image pickup apparatus equipped with a lens barrel. In particular, the present invention relates to a configuration for housing a flexible printed circuit (hereinafter, referred to as an “FPC”) in a lens barrel.

2. Description of Related Art

Recently, a collapsible lens has been mounted on a compact digital still camera in many cases. The collapsible lens has a configuration in which a barrel is movable in an optical axis direction between a housed position in which the barrel is housed in a camera body and a protruding position in which the barrel protrudes from the camera body.

Such a collapsible lens contains a focus lens for autofocusing, and a zoom lens for scaling an optical image. Furthermore, in the vicinity of the focus lens and the zoom lens (movable portions) in the collapsible lens, actuators for driving the focus lens and the zoom lens are placed. Each actuator and an electric circuit board on the camera body side generally are connected to each other electrically with an FPC. With such a configuration, the FPC is configured to be relatively long so as not to prevent the movement of each lens in the optical axis direction.

When the long FPC is mounted, the FPC may be bent and enter an optical path when the focus lens and the zoom lens move in the optical axis direction. Furthermore, the position of the bent FPC is not stable during the assembly of a barrel, so that assembly workability is poor. JP 2003-307667 A discloses a configuration for solving such a problem.

The configuration disclosed in JP 2003-307667 A includes a flexible pressure plate for fixing the FPC. This enables the FPC to be positioned, whereby the FPC can be prevented from entering in the optical path, and the assembly workability can be enhanced.

FIG. 8 is a perspective view showing a configuration of an FPC unit disclosed in JP 2003-307667 A. As shown in FIG. 8, the FPC unit is composed of an FPC 101 and a flexible pressure plate 102. In the FPC 101, bent portions 101a and 101b are formed previously at two places. Furthermore, a left end side in the figure (movable member side) of the FPC 101 is connected to a movable portion in a barrel, and a right end side in the figure (body side) thereof is connected to an electric circuit board of a camera body. The FPC 101 is held on the flexible pressure plate 102, as shown in FIG. 8. In the FPC 101 held on the flexible pressure plate 102, the bent portion 101a is positioned at the flexible pressure plate 102, and a portion on the body side from the bent portion 101a is fixed to the flexible pressure plate 102 with a double-sided tape or the like. Furthermore, the movable member side from the bent portion 101a in the FPC 101 is not fixed to the flexible pressure plate 102, so that the movable member side can move freely in a direction represented by an arrow A or a direction opposite thereto. When the FPC 101 moves in the direction represented by the arrow A or the direction opposite thereto, the bent portion 101b expands or shrinks.

Furthermore, when the FPC unit shown in FIG. 8 is assembled, first, the FPC 101 is bent in a previous process to form the bent portion 101a. Next, the bent portion 101a is inserted in a bent portion 102a of the flexible pressure plate 102. Then, a part of the body side from the bent portion 101a in the FPC 101 is fixed to the flexible pressure plate 102 with a double-sided tape. Next, the FPC 101 is bent substantially in a U-shape to be routed to the movable member side. Consequently, the FPC unit is completed. The assembled FPC unit can be incorporated in a barrel.

However, with the configuration disclosed in JP 2003-307667 A, there is a problem that cost increases, and time and labor are needed for an assembly operation.

More specifically, with the configuration disclosed in JP 2003-307667 A, the flexible pressure plate 102 is required, so that cost increases. Furthermore, a process of forming the bent portion 101a in the FPC 101 is required during assembly of the FPC unit, so that time is consumed for an assembly operation. Furthermore, the FPC 101 is fixed to the flexible pressure plate 102 with a double-sided tape, so that a double-sided tape is required, which increases cost. Furthermore, a process of attaching a double-sided tape is required, so that time and labor are needed for an assembly operation.

### SUMMARY OF THE INVENTION

Therefore, with the foregoing in mind, it is an object of the present invention to provide a lens barrel capable of reducing time and labor during assembly and an image pickup apparatus equipped with the lens barrel at low cost.

A lens barrel of the present invention having at least one lens, includes: a base unit; a movement frame unit movable in an optical axis direction of the lens with respect to the base unit; and a flexible printed circuit including a stationary portion fixed to the movement frame unit and an extension extending from the stationary portion, wherein the base unit includes a protrusion protruding in a direction in which the movement frame unit is placed, the extension is placed so as to extend from the stationary portion to reach at least the base unit or another member via the protrusion, and a part between the stationary portion and the protrusion is placed to be curved substantially in a U-shape.

Furthermore, an image pickup apparatus of the present invention has a lens barrel with at least one lens, and the lens barrel includes: a base unit; a movement frame unit movable in an optical axis direction of the lens with respect to the base unit; and a flexible printed circuit including a stationary portion fixed to the movement frame unit and an extension extending from the stationary portion, wherein the base unit includes a protrusion protruding in a direction in which the movement frame unit is placed, the extension is placed so as to extend from the stationary portion to reach at least the base unit or another member via the protrusion, and a part between the stationary portion and the protrusion is placed to be curved substantially in a U-shape.

In the lens barrel and the image pickup apparatus equipped with the lens barrel of the present invention, a flexible printed circuit can be fixed using only a constituent component of the lens barrel and without using a dedicated member for fixing the flexible printed circuit, whereby the lens barrel and the image pickup apparatus equipped with the lens barrel can be realized at low cost. Furthermore, since assembly becomes simple, time and labor during assembly can be reduced.

In the lens barrel and the image pickup apparatus equipped with the lens barrel of the present invention, cost can be reduced, and time and labor during assembly can be reduced.

### BRIEF DESCRIPTION OF THE DRAWINGS

FIG. 1 is a plan view of a lens barrel in Embodiment 1.

FIG. 2 is a cross-sectional view of the lens barrel in Embodiment 1.

FIG. 3 is a cross-sectional view of the lens barrel in Embodiment 1.

FIG. 4 is a perspective view showing an internal configuration of the lens barrel in Embodiment 1.

FIG. 5 is a perspective view showing a configuration of a third frame in Embodiment 1.

FIG. 6 is a perspective view showing another configuration of the lens barrel in Embodiment 1.

FIG. 7 is a plan view showing a configuration of an FPC in Embodiment 1.

FIG. 8 is a perspective view showing a configuration of a conventional FPC unit.

### DETAILED DESCRIPTION OF THE INVENTION

### Embodiment 1

[1. Configuration of a Lens Barrel]

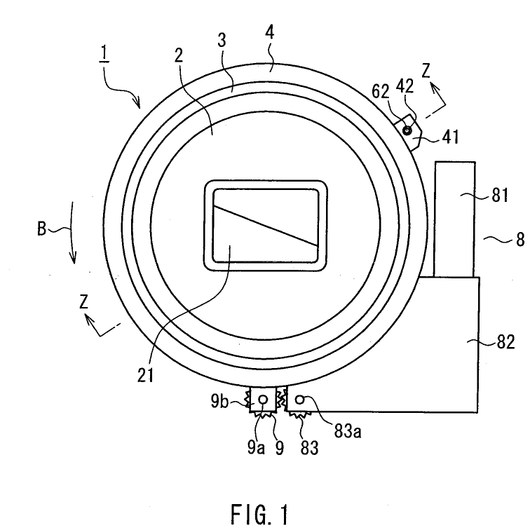

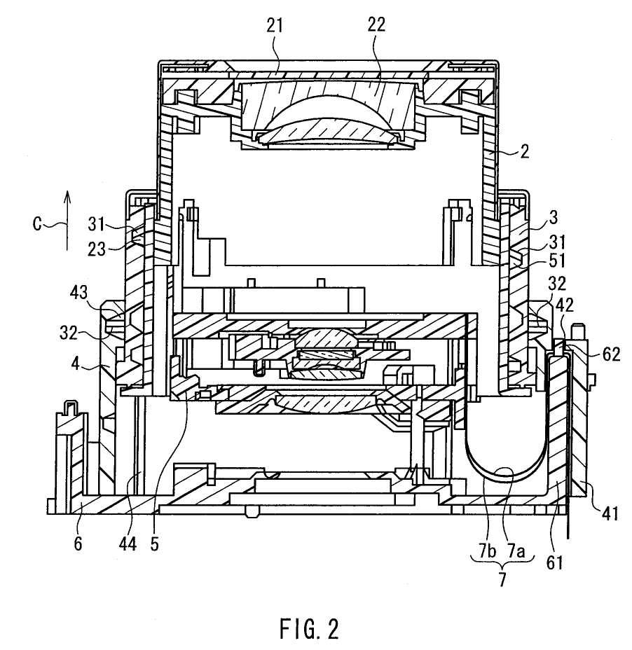

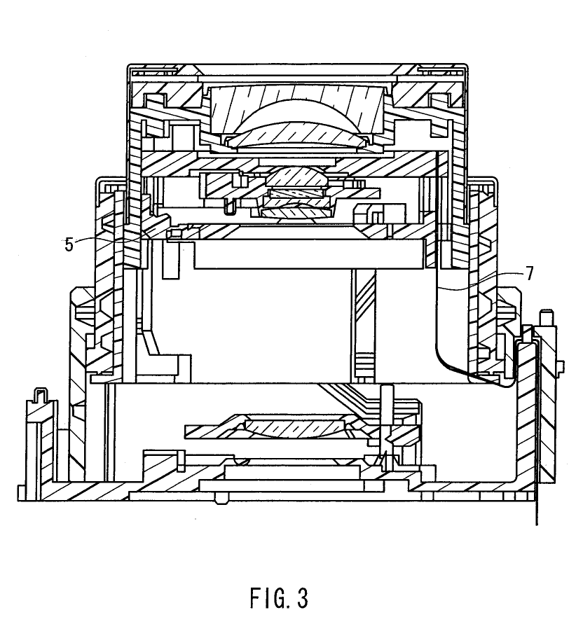

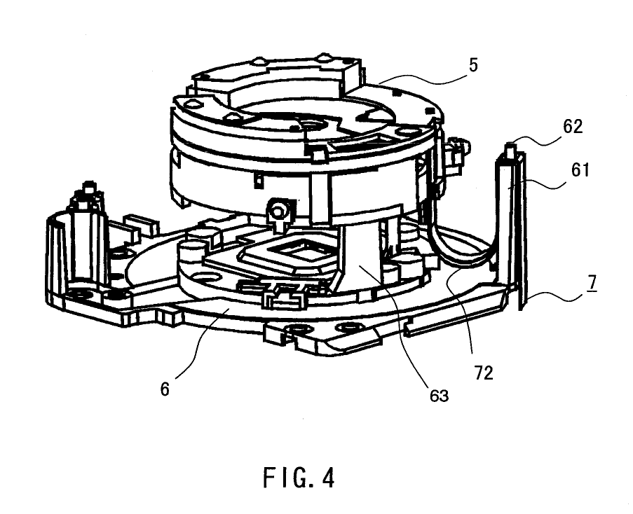

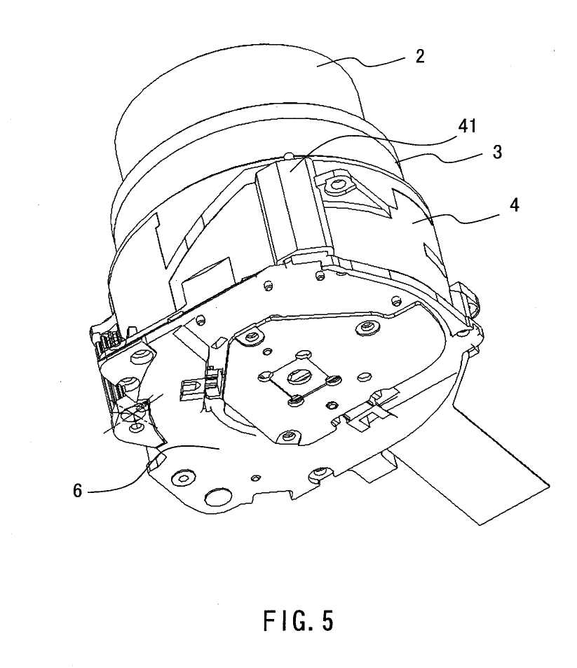

FIG. 1 is a plan view of a lens barrel in Embodiment 1. FIGS. 2 and 3 are cross-sectional views of the lens barrel, showing cross-sections taken along a Z-Z line in FIG. 1. FIG. 2 shows a state in which a movement frame unit (described later) in the lens barrel is being drawn out. FIG. 3 shows a state in which the movement frame unit in the lens barrel has been drawn out as much as possible. In FIGS. 2 and 3, an upper side in the figure of the lens barrel 1 is directed to a subject side during photographing, so that the upper side will be referred to as a “subject side”. A lower side in the figure of the lens barrel 1 contains an image pickup element, so that the lower side will be referred to as an “image surface side”. Furthermore, in FIG. 2 and the like, the movement frame unit is composed of a first frame 2, a second frame 3, and a lens unit 5. Furthermore, a position at which the movement frame unit has been drawn out as much as possible as shown in FIG. 3 will be referred to as a “protruding position”. Furthermore, although not shown, a position at which the movement frame unit is housed in a camera body (not shown) will be referred to as a “housed position”. FIG. 4 is a perspective view showing an internal configuration of the lens barrel. In FIG. 4, components such as a third frame are omitted so that the internal configuration of the lens barrel can be understood easily. FIG. 5 is a perspective view showing a configuration of the third frame.

As shown in FIGS. 1 to 3, the lens barrel 1 includes the first frame 2, the second frame 3, a third frame 4, a lens unit 5, a base unit 6, an FPC 7, an actuator unit 8, and a gear 9. As shown in FIG. 1, the first frame 2, the second frame 3, and the third frame 4 are placed with an optical axis at a center.

The first frame 2 is formed substantially in a cylindrical shape and placed inside the second frame 3. Furthermore, the first frame 2 is placed so as to move in an optical axis direction along a guide groove 44 formed in the third frame 4. Furthermore, the first frame 2 is provided with a guide groove in a direction parallel to an optical axis on an inner circumferential cylindrical surface. Furthermore, the first frame 2 has a lens barrier 21 at an end (uppermost portion in FIG. 2) on the subject side. Furthermore, the first frame 2 holds an objective lens 22 in the vicinity of the end on the subject side.

The lens barrier 21 is composed of two plate members, and is placed so as to move between a dosed position in which the lens barrier 21 covers the objective lens 22 and an opened position in which the lens barrier 21 opens the objective lens 22.

The second frame 3 is formed substantially in a cylindrical shape, and placed rotatably on an inner side of the third frame 4. Furthermore, the second frame 3 is provided with a cam groove 31 on an inner circumferential cylindrical surface.

The cam groove 31 is defined as a continuous groove including a tilted portion formed in a direction tilted with respect to the optical axis direction. The second frame 3 rotates with respect to the optical axis, and a cam pin 23 moves along the tilted portion of the cam groove 31, whereby the first frame 2 moves in the optical axis direction. Furthermore, the second frame 3 includes a cam pin 32 on an outer circumferential cylindrical surface.

The cam pin 32 is formed so as to protrude from the outer circumferential cylindrical surface of the second frame 3. Furthermore, the cam pin 32 is fitted in a cam groove 43 movably.

The third frame 4 (outside frame) is formed substantially in a cylindrical shape as shown in FIG. 5 and fixed to the camera body. Furthermore, a cover 41 is formed on the third frame 4 so as to protrude from the outer circumferential cylindrical surface thereof. A hole 42 is formed at an end on the subject side of the cover 41. The cam groove 43 is formed on the inner circumferential cylindrical surface of the third frame 4.

The cam groove 43 is defined as a continuous groove including a portion formed in a direction orthogonal to the optical axis of the third frame 4, and a tilted portion formed in a direction tilted with respect to the optical axis direction. When the second frame 3 rotates with respect to the optical axis, the cam pin 32 moves in the tilted portion of the cam groove 43, whereby the second frame 3 moves in the optical axis direction. Furthermore, a guide groove 44 is formed in a direction parallel to the optical axis direction on the inner circumferential cylindrical surface of the third frame 4.

A protrusion (not shown) formed on the outer circumferential cylindrical surface of the first frame 2 is fitted in the guide groove 44 movably. Consequently, when the first frame 2 moves in the optical axis direction, the movement in the optical axis direction is guided while the movement in a circumferential direction with respect to the optical axis is regulated.

The lens unit 5 includes at least a zoom lens and an actuator for moving the zoom lens in the optical axis direction. Furthermore, the second frame 3 rotates with respect to the optical axis, whereby the lens unit 5 can move in the optical axis direction. The lens unit 5 is provided with a cam pin 51 on an outer circumferential cylindrical surface thereof. Furthermore, on the outer circumferential cylindrical surface of the lens unit 5, there is a pin (not shown) that can be fitted in a guide groove (not shown) formed on the inner circumferential cylindrical surface of the first frame 2.

The cam pin 51 is formed so as to protrude from the outer circumferential cylindrical surface of the lens unit 5. Furthermore, the cam pin 51 is fitted in the cam groove 31 movably.

The base unit 6 is a member substantially in a plate shape, which is attached to a bottom surface of the third frame 4 integrally. Furthermore, on the base unit 6, an image pickup element such as a CCD image sensor, an electric circuit board for operating the image pickup element, an FPC for electrically connecting the electric circuit board to an electric circuit board contained in the camera body, and the like are provided. The base unit 6 is provided with a protrusion 61 in the vicinity of an outer periphery on a principal plane.

The protrusion 61 has a substantially columnar shape, and is formed so as to protrude toward the objective lens 22 side. Furthermore, the protrusion 61 is formed so as to hold the FPC drawn outside from the lens barrel 1. The longitudinal length of the protrusion 61 is set so that the bent FPC 7 does not come into contact with the base unit 6 and other members when the lens unit 5 is placed at a position where the lens unit 5 is drawn in most toward the image surface side of the image pickup element. More specifically, if the protrusion is too short, the bent amount of the FPC 7 becomes too small, so that the movement amount of the lens unit 5 becomes small. On the other hand, when the protrusion 61 is too long, the length of the FPC 7 needs to be large, which leads to an increase in cost. In the present embodiment, the longitudinal length of the protrusion 61 is set to be substantially equal to that of the height of the third frame 4. However, the present invention is not limited thereto. Furthermore, a pin 62 is formed at a tip end of the protrusion 61.

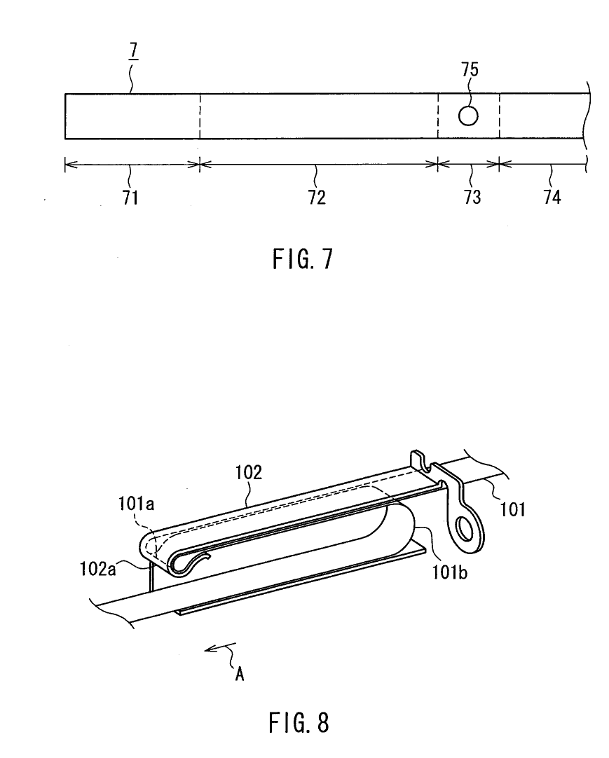

The pin 62 is formed so as to protrude to the subject side at the tip end of the protrusion 61. Furthermore, although the pin 62 is formed substantially in a cylindrical shape in the present embodiment, it may be formed in another shape such as a prism shape. Furthermore, the outer diameter of the pin 62 may have a dimension so that the pin 62 can be fitted in a hole 75 formed in the FPC 7 (FIG. 7), and in the present embodiment, the pin 62 is formed with a dimension slightly larger than an inner diameter of the hole 75. By providing the pin 62 with a prism shape and the hole 75 with a square hole shape, the FPC 7 is positioned when the lens barrel 1 is assembled, so that the assembly workability can be enhanced, and the position of the FPC 7 after assembly can be stabilized.

The FPC 7 can electrically connect the actuator provided in the lens unit 5 to the electric circuit board placed on the base unit 6 or the electric circuit board on the camera body side. The FPC 7 is configured as shown in a plan view showing main portions of FIG. 7. As shown in FIG. 7, the FPC 7 includes at least a stationary portion 71 electrically connected to the lens unit 5, a lead portion 72 that can be curved substantially in a U-shape as shown in FIG. 2, when the FPC 7 is incorporated in the lens barrel 1, a retention portion 73 at the tip end of the protrusion 61, and a lead portion 74 positioned between the cover 41 and the protrusion 61. Herein, an extension is composed of the lead portion 72, the retention portion 73, and the lead portion 74. In the retention portion 73, the hole 75 in which the pin 62 can be fitted is formed. Broken lines shown in FIG. 7 represent boundaries of the respective portions, and do not represent folds formed in the FPC 7 in a previous process and the like.

Furthermore, as shown in FIGS. 2 and 3, although the FPC 7 is wired with two FPCs 7a and 7b overlapping each other, the FPC 7 may be similarly wired even with one FPC. In the case where the FPC 7 is wired with a plurality of FPCs overlapping each other, the hole 75 is formed in each FPC, whereby the plurality of FPCs can be fixed to the protrusion 61 easily by a fixing system similar to that in the case of one FPC 7. In this case, if the pin 62 is press-fitted or lightly press-fitted in the hole 75 of the FPC (i.e., the FPC placed in an uppermost stage in a shaft direction of the pin 62, corresponding to, for example, the FPC 7a in FIG. 2) to be held by the pin 62 last when the plurality of FPCs 7 are held by the pin 62 under the condition that they overlap each other, the plurality of FPCs 7 can be fixed to the protrusion 61 provisionally. Thus, it is not necessary to press-fit or lightly press-fit the pin 62 in the holes 75 of all the FPCs 7.

Furthermore, in the case where the length from the end of the stationary portion 71 to the hole 75 is the same in the plurality of FPCs 7, when the lead portion 72 (see FIG. 7) is bent as shown in FIG. 2, the FPCs 7 rub against each other when the movement frame unit moves in a direction represented by an arrow C or a direction opposite thereto, with the results that the surfaces of the FPCs 7 may be damaged, and lead wires contained in the FPCs 7 may be disconnected. In the present embodiment, in the plurality of FPCs 7, the length from the end of the stationary portion 71 to the hole 75 is varied for each FPC. Specifically, the length of the FPC 7a positioned closest to the subject side is set to be shortest, and the length of the FPC 7b positioned closest to the image surface side is set to be longest. With such a configuration, when the movement frame unit moves in the direction represented by the arrow C or the direction opposite thereto, the FPCs 7 do not rub against each other, so that damage to the surface of each FPC 7 or the disconnection of the lead wire contained therein can be prevented. Furthermore, the length of the lead portion 72 of each FPC is determined only by component precision, so that the variation caused by an assembly operation does not occur, and high quality can be maintained.

The actuator unit 8 includes an actuator 81, an actuator holder 82, and a gear 83. The actuator 81 is supplied with a current, whereby an output shaft (not shown) rotates. The actuator 81 is a driving source for moving the movement frame unit between the housed position and the protruding position. The actuator holder 82 holds the actuator 81, and also is held on the outer circumferential cylindrical surface of the third frame 4. Furthermore, the actuator holder 82 contains a gear string to be engaged with the output shaft of the actuator 81. The gear 83 is held rotatably on the actuator holder 82 by a support shaft 83a. The gear 83 is engaged with the gear string contained in the actuator holder 82, and is engaged with the gear 9.

The gear 9 is supported rotatably on a holder 9b placed on the outer circumferential cylindrical surface of the third frame 4 by a support shaft 9a. Furthermore, the gear 9 is engaged with the gear 83, and is engaged with a gear (not shown) formed on the outer circumferential cylindrical surface of the second frame 3. Thus, the rotation driving force output from the actuator 81 is transmitted to the gear string in the actuator holder 82, the gear 83, the gear 9, and the gear formed on the outer circumferential cylindrical surface of the second frame 3 in this order, thereby rotating the second frame 3.

### [2. Operation of a Lens Barrel]

As shown in FIG. 1, in the case where the lens barrel in Embodiment 1 is mounted on a digital still camera, when the digital still camera is in an OFF state, the first frame 2, the second frame 3, and the lens unit 5 are housed in the third frame 4. More specifically, the lens barrel 1 is housed in the camera body without protruding therefrom. For convenience of description, figures showing a state in which the lens barrel 1 is housed in the camera body and a state in which the first and second frames 3 are housed in the third frame 4 are omitted.

When the power of the digital still camera is switched from an OFF state to an ON state, the actuator 81 is supplied with a current to start an operation. When the actuator 81 starts the operation, the output shaft starts rotating. The rotation driving force of the output shaft is transmitted to the gear 83 through the gear string contained in the actuator holder 82. The rotation driving force transmitted to the gear 83 is transmitted to the gear formed on the outer circumferential cylindrical surface of the second frame 3 via the gear 9. Consequently, the second frame 3 rotates in a direction represented by an arrow B.

Next, as shown in FIG. 2, when the second frame 3 rotates, the cam pin 32 moves along the cam groove 43. When the cam pin 32 moves along the tilted portion of the cam groove 43, the second frame 3 moves in the direction represented by the arrow C. More specifically, the second frame 3 moves in the direction represented by the arrow C while rotating in the direction represented by the arrow B. The first frame 2 moves in the direction represented by the arrow C integrally along with the movement of the second frame 3.

Furthermore, when the second frame 3 rotates, the cam groove 31 moves relatively with respect to the cam pin 51. When the cam pin 51 moves along the tilted portion of the cam groove 31, the lens unit 5 moves in the direction represented by the arrow C. The lens unit 5 moves in the direction represented by the arrow C while its rotation in the direction represented by the arrow B or the direction opposite thereto is being regulated, since the pin formed so as to protrude from the outer circumferential cylindrical surface of the lens unit 5 and the guide groove formed on the inner circumferential surface of the first frame 2 are fitted in each other movably.

Thus, when the second frame 3 rotates, the first frame 2, the second frame 3, and the lens unit 5 move in the direction represented by the arrow C. Since the third frame 4 and the base unit 6 are fixed to the camera body, they do not move.

As shown in FIG. 3, when the first frame 2 and the second frame 3 are drawn out as much as possible, the lens unit 5 has moved to the vicinity of the objective lens 22. Furthermore, the lens barrier 21 is opened. In this state, a subject can be photographed.

Next, the movement of the FPC 7 at a time when the lens barrel 1 is operated will be described.

As shown in FIG. 2, the stationary portion 71 that is one end of the FPC 7 is fixed to the lens unit 5. The lead portion 72 is wired from the lens unit 5 toward the image surface side, curved by about 180° substantially in a U-shape, and wired toward the subject side. The retention portion 73 is held at the tip end of the protrusion 61. The lead portion 74 is wired from the tip end of the protrusion 61 toward the image surface side, and routed outside of the lens barrel 1 through between the cover 41 and the protrusion 61. The retention portion 73 can be held at the tip end of the protrusion 61 by inserting the pin 62 in the hole 75. Furthermore, the retention portion 73 is sandwiched between the cover 41 and the tip end of the protrusion 61, which prevents the retention portion 73 from coming off the protrusion 61. Herein, since the pin 62 is inserted in the hole 42 formed in the cover 4, the retention portion 73 is prevented from coming off the pin 62.

When the second frame 3 rotates and the lens unit 5 moves in the direction represented by the arrow C when the FPC 7 is bent as shown in FIG. 2, the FPC 7 is pulled in the direction represented by the arrow C since one end thereof is fixed to the lens unit 5, whereby the state shown in FIG. 3 is obtained. Since the FPC 7 is wired with a length having a clearance, no undue tension is applied even if the state shifts to that shown in FIG. 3. Accordingly, disconnection of the lead wire in the FPC 7 can be avoided.

Furthermore, since the retention portion 73 is held at the tip end of the protrusion 61, and the third frame 4 and the base unit 6 are fixed to the camera body, when the FPC 7 shifts from the state shown in FIG. 2 to the state shown in FIG. 3, the positions of the retention portion 73 and the lead portion 74 do not change.

### [3. Method for Assembling a Lens Barrel]

A method for assembling the lens barrel 1 will be described, assuming that the first frame 2, the second frame 3, and the lens unit 5 are integrated with each other to form a unit (movement frame unit). Furthermore, it is assumed that the stationary portion 71 of the FPC 7 is previously fixed to the lens unit 5.

First, the FPC 7 is placed on the protrusion 61. Specifically, the pin 62 formed on the protrusion 61 is inserted in the hole 75 formed in the FPC 7.

Next, the movement frame unit is placed on the base unit 6. Specifically, a protrusion 63 (see FIG. 4) formed on the base unit 6 is inserted in an opening (not shown) formed on a surface of the lens unit 5 opposed to the image surface, and the movement frame unit is placed on a principal surface (i.e., a surface on which the protrusion 63 is formed) of the base unit 6. The movement frame unit is positioned by the protrusion 63. At this time, the FPC 7 is set in such a state that the lead portion 72 is curved substantially in a U-shape as shown in FIG. 4.

Next, the third frame 4 is placed on the base unit 6. Specifically, after the cover 41 and the protrusion 61 are aligned, the third frame 4 is placed with respect to the movement frame unit from the subject side. That is, the third frame 4 is fitted along the outer circumferential cylindrical surface of the second frame 3 from the upper side of the lens barrel 1 in FIG. 2. Consequently, the pin 62 is inserted in the hole 42, whereby the protrusion 61 and the cover 41 are positioned. Furthermore, since the pin 62 is fitted in the hole 75 of the FPC 7, the pin 62 is inserted in the hole 42, whereby the FPC 7 can be regulated so as not to come off the pin 62. Furthermore, the cam pin 32 formed on the outer circumferential cylindrical surface of the second frame 3 is fitted in the cam groove 43. Furthermore, the gear portion formed on the outer circumferential cylindrical surface of the second frame 3 is engaged with the gear 9.

Next, the actuator unit 8 is placed on the third frame 4. Specifically, the actuator unit 8 is fixed to the outer circumferential cylindrical surface of the third frame 4 as shown in FIG. 1. At this time, the gears 83 and 9 are engaged with each other. Although a specific method for fixing the actuator unit 8 and the third frame 4 to each other is not shown, for example, by fitting a pin formed on the actuator holder 82 in a concave portion formed on the third frame 4, the actuator unit 8 can be fixed to the third frame 4.

Accordingly, the lens barrel 1 is completed.

### [4. Effects of an Embodiment, etc.]

The lens barrel 1 in Embodiment 1 has at least one lens, and includes the base unit 6, the lens unit 5 movable in the optical axis direction of the lens with respect to the base unit 6, and the FPC 7 having the stationary portion 71 fixed to the lens unit 5. The base unit 6 includes the protrusion 61 protruding in the direction in which the lens unit 5 is placed. The FPC 7 includes the lead portion 72 placed so as to be curved substantially in a U-shape between the stationary portion 71 and the retention portion 73. Because of this, a dedicated member for fixing the FPC is not required, so that a parts count can be reduced. Furthermore, the reduction in the parts count leads to the reduction in cost and the miniaturization of the apparatus.

Furthermore, even if the lens unit 5 advances and retreats repeatedly, an excess local load is not applied to the FPC 7 (in particular, the lead portion 72), so that the reliability of the FPC can be ensured.

Furthermore, the lens barrel 1 in Embodiment 1 further includes the third frame 4 that covers at least the lens unit 5 and the protrusion 61. This can prevent the lead portion 72 from coming into contact with another member to damage the lead portion 72.

Furthermore, in the lens barrel 1 in Embodiment 1, the hole 75 is formed in the retention portion 73 of the FPC 7, and the pin 62 is formed on the protrusion 61 of the base unit 6. Then, by inserting the pin 62 in the hole 75, the retention portion 73 can be held on the protrusion 61. Consequently, an adhesive member such as a double-sided tape is not required for fixing a part (retention portion 73) of the FPC 7 to the protrusion 61, so that cost can be reduced. Furthermore, an attachment process is not required, so that the assembly man-hours can be reduced.

Furthermore, when a plurality of FPCs 7 are wired so as to overlap each other, the FPCs 7 are wired in such a manner that the length from the stationary portion 71 to the hole 75 of the FPC 7a positioned on the subject side is longer than that from the stationary portion 71 to the hole 75 of the FPC 7b positioned on the image surface side. Because of this, even in the case where the lens unit 5 advances and retreats repeatedly in the optical axis direction when the plurality of FPCs 7 are placed so as to overlap each other, the FPCs 7 do not interfere with each other (rub against each other) in the lead portions 72, so that the damage of each FPC 7 and the disconnection of a lead wire contained in each FPC 7 can be prevented. Thus, the reliability of the FPC 7 can be ensured. Furthermore, the following inconvenience can be prevented: one FPC 7 of the plurality of FPCs 7 interferes with another, with the result that the FPC 7 is bent in an unexpected direction.

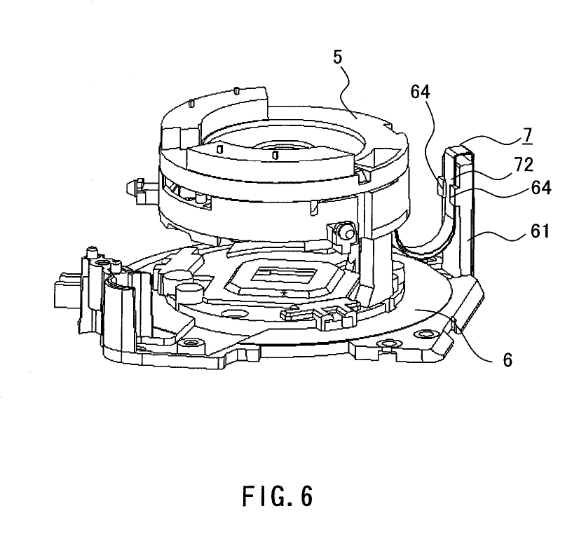

Although the member holding the FPC 7 is formed at the tip end of the protrusion 61 as in the pin 62 in Embodiment 1, the member may be formed on the side surface of the protrusion 61. FIG. 6 shows an example in which the member holding the FPC is formed on the side surface of the protrusion 61. In FIG. 6, components such as the third frame are omitted so that the internal configuration of the lens barrel 1 can be understood easily. In the configuration shown in FIG. 6, a hook 64 is formed on the side surface of the protrusion 61. By engaging a part of the lead portion 72 with the hook 64, the lead portion 72 can be held along the side surface of the protrusion 61.

Furthermore, the pin 62 can be formed on the side surface of the protrusion 61 instead of the tip end of the protrusion 61. In this case, the pin 62 is formed on a reverse surface of a surface of the protrusion 61 opposed to the lens unit 5. Furthermore, a groove is formed in a longitudinal direction of the cover 41 on an inside surface of the cover 41 opposed to the side surface of the protrusion 61. The groove is formed so that the pin 62 can move inside the groove when the third frame 4 is placed on the base unit 6 from the upper side of the lens barrel 1 during assembly of the lens barrel 1, and is formed so that the pin 62 is positioned inside the groove while holding the FPC 7 when the third frame 4 is placed on the base unit 6. Because of this, an effect similar to that of the configuration in which the pin 62 is formed at the tip end of the protrusion 61 can be obtained.

Furthermore, the lead portion 72 also can be fixed using both the pin 62 and the hook 64.

The present invention can be applied to any lens barrel that is movable in the optical axis direction, and has a movement frame unit that electrically connects one unit to another unit. Such a lens barrel can be provided in an image pickup apparatus. Examples of the image pickup apparatus include a digital still camera, a video camera, a mobile telephone terminal with a camera, and the like.

### [Note 1]

A lens barrel of the present invention having at least one lens includes: a base unit; a movement frame unit movable in an optical axis direction of the lens with respect to the base unit; and a flexible printed circuit including a stationary portion fixed to the movement frame unit and an extension extending from the stationary portion, wherein the base unit includes a protrusion protruding in a direction in which the movement frame unit is placed, the extension is placed so as to extend from the stationary portion to reach at least the base unit or another member via the protrusion, and a part between the stationary portion and the protrusion is placed to be curved substantially in a U-shape.

In the above-mentioned configuration, the movement frame unit is composed of the first frame 2, the second frame 3, and the lens unit 5 in Embodiment 1. The number of the frames constituting the movement frame unit may be at least three, instead of two as in Embodiment 1. Furthermore, the lens unit 5 is not limited to a configuration including only an optical lens such as a zoom lens, and may include components other than the optical lens, such as an image fluctuation correcting device or a diaphragm.

The stationary portion 71 is an example of the stationary portion. The protrusion 61 is an example of the protrusion. The lead portion 72, the retention portion 73, and the lead portion 74 are examples of the extension.

### [Note 2]

The lens barrel of the present invention can be configured so as to further include an outside frame covering at least the movement frame unit and the protrusion. Due to this configuration, the flexible printed circuit can be fixed exactly by a simple method, without using an adhesive member such as a double-sided tape.

The third frame 4 is an example of the outside frame.

### [Note 3]

The lens barrel of the present invention can be configured so as to include a hole in the extension and a pin on the protrusion, wherein the pin is inserted in the hole, whereby the extension is held on the protrusion at least in the hole. Due to this configuration, the flexible printed circuit can be fixed exactly by a simple method, without using an adhesive member such as a double-sided tape.

The hole 75 is an example of the hole. It is not necessary that the hole is composed of a through-hole as in Embodiment 1, and may be formed in a concave (non-through) shape seen from the protrusion 61 side. The pin 62 is an example of the pin.

### [Note 4]

The lens barrel of the present invention can be configured so as to include the pin at a tip end of the protrusion. Due to this configuration, the flexible printed circuit can be fixed exactly by a simple method, without using an adhesive member such as a double-sided tape.

### [Note 5]

The lens barrel of the present invention can be configured so as to include the pin on a side surface of the protrusion. Due to this configuration, the flexible printed circuit can be fixed exactly by a simple method, without using an adhesive member such as a double-sided tape.

### [Note 6]

The lens barrel of the present invention can be configured so as to include a hook capable of holding a part of the extension on the protrusion, wherein the extension is held partially on the hook, and held on the protrusion at least in the part held on the hook. Due to this configuration, the flexible printed circuit can be fixed exactly by a simple method, without using an adhesive member such as a double-sided tape.

The hook 64 is an example of the hook. The hook is not limited to the shape of the hook 64, and may be configured so as to hold at least the FPC 7 on the protrusion 61.

### [Note 7]

The lens barrel of the present invention can be configured so that the hook is provided on the side surface of the protrusion. Due to this configuration, the flexible printed circuit can be fixed exactly by a simple method, without using an adhesive member such as a double-sided tape.

### [Note 8]

The lens barrel of the present invention can be configured so as to include a plurality of the flexible printed circuits, wherein in the plurality of flexible printed circuits, a part between the stationary portion and the protrusion in the extension is placed to be curved substantially in a U-shape, and in the part curved in the U-shape, a length from the stationary portion to the protrusion of the flexible printed circuit in the U-shape placed inside is smaller than that from the stationary portion to the protrusion of the flexible printed circuit in the U-shape placed outside. Due to this configuration, when the flexible printed circuits are bent repeatedly, the flexible printed circuits can be prevented from rubbing against each other. Thus, the inconvenience such as the disconnection in the flexible printed circuit can be prevented from occurring. Furthermore, such a configuration can be realized easily.

### [Note 9]

An image pickup apparatus of the present invention has a lens barrel with at least one lens, the lens barrel including: a base unit; a movement frame unit movable in an optical axis direction of the lens with respect to the base unit; and a flexible printed circuit including a stationary portion fixed to the movement frame unit and an extension extending from the stationary portion, wherein the base unit includes a protrusion protruding in a direction in which the movement frame unit is placed, the extension is placed so as to extend from the stationary portion to reach at least the base unit or another member via the protrusion, and a part between the stationary portion and the protrusion is placed to be curved substantially in a U-shape.

The first frame 2, the second frame 3, and the lens unit 5 are examples of the movement frame unit. The number of the frames constituting the movement frame unit may be at least three, instead of two as in Embodiment 1. Furthermore, the lens unit 5 is not limited a configuration including only an optical lens such as a zoom lens, and may include components other than the optical lens, such as an image fluctuation correcting device or a diaphragm. The stationary portion 71 is an example of the stationary portion. The protrusion 61 is an example of the protrusion. The lead portion 72, the retention portion 73 and the lead portion 74 are examples of the extension.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A lens barrel having at least one lens, comprising:
a base unit;
a movement frame unit movable in an optical axis direction of the lens with respect to the base unit; and
a flexible printed circuit including a stationary portion fixed to the movement frame unit and an extension extending from the stationary portion,
wherein the base unit includes a protrusion protruding in a direction in which the movement frame unit is placed,
the extension is placed so as to extend from the stationary portion to reach at least the base unit or another member via the protrusion, and
a part between the stationary portion and the protrusion is placed to be curved substantially in a U-shape.

2. The lens barrel according to claim 1, further comprising an outside frame covering at least the movement frame unit and the protrusion.

3. The lens barrel according to claim 1, comprising a hole in the extension and a pin on the protrusion,
wherein the pin is inserted in the hole, whereby the extension is held on the protrusion at least in the hole.

4. The lens barrel according to claim 3, comprising the pin at a tip end of the protrusion.

5. The lens barrel according to claim 3, comprising the pin on a side surface of the protrusion.

6. The lens barrel according to claim 1, comprising a hook capable of holding a part of the extension on the protrusion,
wherein the extension is held partially on the hook, and held on the protrusion at least in the part held on the hook.

7. The lens barrel according to claim 6, wherein the hook is provided on the side surface of the protrusion.

8. The lens barrel according to claim 1, comprising a plurality of the flexible printed circuits,
wherein in the plurality of flexible printed circuits, a part between the stationary portion and the protrusion in the extension is placed to be curved substantially in a U-shape, and
in the part curved in the U-shape, a length from the stationary portion to the protrusion of the flexible printed circuit in the U-shape placed inside is smaller than that from the stationary portion to the protrusion of the flexible printed circuit in the U-shape placed outside.

9. An image pickup apparatus having a lens barrel with at least one lens,
the lens barrel comprising:
a base unit;
a movement frame unit movable in an optical axis direction of the lens with respect to the base unit; and
a flexible printed circuit including a stationary portion fixed to the movement frame unit and an extension extending from the stationary portion,
wherein the base unit includes a protrusion protruding in a direction in which the movement frame unit is placed,
the extension is placed so as to extend from the stationary portion to reach at least the base unit or another member via the protrusion, and a part between the stationary portion and the protrusion is placed to be curved substantially in a U-shape.
